(19) United States
(12) Patent Application Publication
(10) Pub. No.: US 2024/0194382 A1
(43) Pub. Date: Jun. 13, 2024

(54) NANOCRYSTALLINE SOFT MAGNETIC MATERIAL

(71) Applicant: DAIDO STEEL CO., LTD., Nagoya-shi (JP)

(72) Inventor: Yuya TOMITA, Nagoya-shi (JP)

(21) Appl. No.: 18/527,554

(22) Filed: Dec. 4, 2023

(30) Foreign Application Priority Data
Dec. 7, 2022 (JP) JP 2022-195522
Aug. 10, 2023 (JP) JP 2023-131660

(51) Int. Cl. H01F 1/147; C22C 38/00; C22C 38/02; C22C 38/12; C22C 38/16

(52) U.S. Cl. CPC H01F 1/14766; C22C 38/002; C22C 38/02; C22C 38/12; C22C 38/16; C22C 2200/04; C22C 2202/02

(57) ABSTRACT

The present invention relates to a nanocrystalline soft magnetic material in which Fe—Si crystal grains having an average grain diameter of 20 nm or less are dispersed in an amorphous matrix phase, the nanocrystalline soft magnetic material including: an alloy composition including, in terms of at %, Si: 14.0% to 18.0%, B: 6.0% to 10.0%, Nb: 1.0% to 5.0%, Cu: 0.5% to 1.5%, and C: more than 0.40% to 1.0%, with the balance being Fe and unavoidable impurities, in which the nanocrystalline soft magnetic material has a coercive force Hc of 1.0 A/m or less and a saturation magnetic flux density Bs of larger than 1.0 T.

### CROSS-REFERENCE TO RELATED APPLICATIONS

This application is based on and claims priority under 35 USC 119 from Japanese Patent Applications No. 2022-195522 filed on Dec. 7, 2022 and No. 2023-131660 filed on Aug. 10, 2023, the contents of which are incorporated herein by reference.

### TECHNICAL FIELD

The present invention relates to a Fe-based nanocrystalline soft magnetic material in which fine crystal grains are dispersed in an amorphous matrix phase.

### BACKGROUND ART

A nanocrystalline soft magnetic material is a soft magnetic alloy material that exhibits a high permeability due to formation of a multiphase structure of a fine crystalline phase and an amorphous phase. Generally, the nanocrystalline soft magnetic material is produced by subjecting an amorphous alloy to a heat treatment and precipitating a fine crystalline phase of nanometer order in a matrix phase composed of an amorphous phase.

For example, Patent Literature 1 discloses a Fe-based soft magnetic material that is made of a Fe-based alloy in which Cu and at least one element selected from the group consisting of Nb, W, Ta, Zr, Hf, Ti, and Mo are added in combination to an alloy containing Fe and an amorphous-phase-forming element such as Si or B as basic components, and in which most of a structure is formed into fine crystal grains by subjecting an amorphous alloy to an appropriate heat treatment. Here, it is also disclosed that stability of a magnetic property can be improved by adding at least one element selected from Li, Mg, Ca, Sr, Ba, Ag, Cd, Pb, Bi, N, O, S, Se, Te, and the like.
Patent Literature 1: JP H01-39347A

### SUMMARY OF INVENTION

In order to increase a permeability of a nanocrystalline soft magnetic material, it is considered to bring a magnetostriction close to 0. However, the permeability is proportional to a reciprocal of the magnetostriction, and the permeability greatly varies according to a slight variation in the magnetostriction. Therefore, there has been a problem that a permeability property may become unstable due to a slight deviation in heat treatment conditions or a slight variation in a magnetostriction value depending on a heat treatment lot. Therefore, it is required to industrially stably produce a nanocrystalline soft magnetic material having a high permeability.

The present invention has been made in view of the above circumstances, and an object thereof is to provide a Fe-based nanocrystalline soft magnetic material in which fine crystal grains are dispersed in an amorphous matrix phase by a heat treatment and in which a variation in a magnetostriction in the heat treatment can be reduced.

A nanocrystalline soft magnetic material according to an aspect of the present invention is a nanocrystalline soft magnetic material in which Fe—Si crystal grains having an average grain diameter of 20 nm or less are dispersed in an amorphous matrix phase, the nanocrystalline soft magnetic material including an alloy composition including, in terms of at %, Si: 14.0% to 18.0%, B: 6.0% to 10.0%, Nb: 1.0% to 5.0%, Cu: 0.5% to 1.5%, and C: more than 0.40% to 1.0%, with the balance being Fe and unavoidable impurities, in which the nanocrystalline soft magnetic material has a coercive force Hc of 1.0 A/m or less and a saturation magnetic flux density Bs of larger than 1.0 T.

According to such a feature, it is possible to improve stability of a degree of order against heat treatment conditions and reduce a variation in a magnetostriction caused by a heat treatment.

A nanocrystalline soft magnetic material according to another aspect of the present invention is a nanocrystalline soft magnetic material in which Fe—Si crystal grains having an average grain diameter of 20 nm or less are dispersed in an amorphous matrix phase, the nanocrystalline soft magnetic material having an alloy composition including, in terms of at %, Si: 14.0% to 18.0%, B: 6.0% to 10.0%, Nb: 1.0% to 5.0%, Cu: 0.5% to 1.5%, and at least one kind selected from the group consisting of C, P, and S provided that at least P or S is contained such that 0.01≤[C]+[P]+2[S]≤1.00 is satisfied, where [M]% is at % of an element M, with the balance being Fe and unavoidable impurities, in which the nanocrystalline soft magnetic material has a coercive force Hc of 1.0 A/m or less and a saturation magnetic flux density Bs of larger than 1.0 T.

According to such a feature, it is possible to improve stability of a degree of order against heat treatment conditions and reduce a variation in a magnetostriction caused by a heat treatment.

In the above-described invention, the alloy composition may contain, in terms of at %, S: 0.01% to 0.10%. According to such a feature, it is possible to improve the stability of the degree of order against the heat treatment conditions, reduce the variation in the magnetostriction caused by the heat treatment, and maintain a low coercive force.

In the above-described invention, the Fe—Si crystal grains may include a multiphase structure of a B2 phase and a D0₃ phase and have an order parameter S represented described below of 20 to 30. According to such a feature, it is possible to reduce the variation in the magnetostriction caused by the heat treatment.

S=v_{cry}·(χ_{D03}−χ_{B2}) Expression (1),

in Expression (1), v_{cry} represents a volume fraction (%) of a nanocrystalline phase, χ_{B2} represents an amount (%) of B2 phase, and χ_{D03} represents an amount (%) of D0₃ phase.

In the above-described invention, an initial permeability may be 100,000 or more.

In the above-described invention, no compound formed between Fe, and C, P, or S may be contained.

### BRIEF DESCRIPTION OF DRAWINGS

FIG. 1 is a graph showing a correlation between a coercive force and a degree of order;

FIG. 2A is a graph showing a relationship between an order parameter and a magnetostriction constant;

FIG. 2B is a graph showing a relationship between an order parameter and a coercive force Hc;

FIG. 3A is a list of component compositions and test results of alloys used in a preliminary test;

FIG. 3B is a list of component compositions and test results of alloys used in a preliminary test;

FIG. 4A is a list of component compositions and test results of alloys used in a production test;

FIG. 4B is a list of component compositions and test results of alloys used in a production test;

FIG. 4C is a list of component compositions and test results of alloys used in a production test; and

FIG. 4D is a list of component compositions and test results of alloys used in a production test.

### DESCRIPTION OF EMBODIMENTS

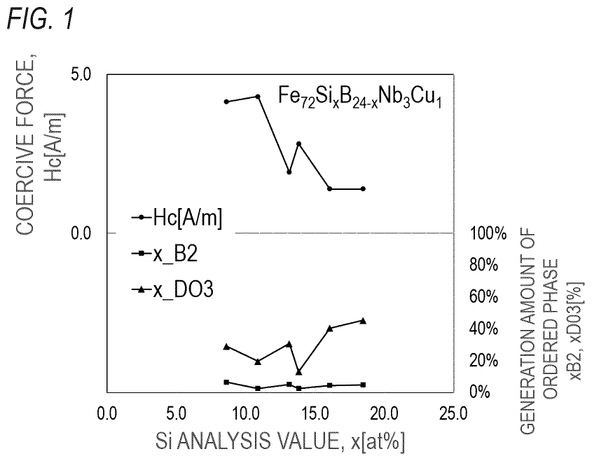

A nanocrystalline soft magnetic material as one example according to the present invention will be described with reference to FIG. 1.

In a nanocrystalline soft magnetic material according to an aspect in the present embodiment, Fe—Si crystal grains having an average grain diameter of 20 nm or less are dispersed in an amorphous matrix phase. The Fe—Si crystal grains may include a multiphase structure of a B2 phase and a D0₃ phase, which are ordered phases including an ordered structure. The nanocrystalline soft magnetic material is composed of a Fe-based alloy including an alloy composition including, in terms of at %, Si: 14.0% to 18.0%, B: 6.0% to 10.0%, Nb: 1.0% to 5.0%, Cu: 0.5% to 1.5%, and C: more than 0.40% to 1.0% (0.40%≤C≤1.0%).

A nanocrystalline soft magnetic material according to another aspect in the present embodiment is composed of a Fe-based alloy including an alloy composition including, in terms of at %, Si: 14.0% to 18.0%, B: 6.0% to 10.0%, Nb: 1.0% to 5.0%, Cu: 0.5% to 1.5%, and at least one kind selected from the group consisting of C, P, and S provided that at least P or S is contained such that 0.01≤[C]+[P]+2[S]≤1.00 is satisfied, where [M]% represents at % of an element M. Among these, particularly S is preferably 0.01% to 0.10%. [C]+[P]+2[S] is preferably 0.50 or less, more preferably 0.10 or less.

Here, as shown in FIG. 1, the present inventors have found that there is a correlation between an ordered phase of the Fe—Si crystal grains and a coercive force. According to FIG. 1, the coercive force tends to decrease as a Si content increases. However, detailed increase and decrease thereof are unstable. In contrast, when increase and decrease in a generation amount of each of the B2 phase and the D0₃ phase are compared with increase and decrease in the coercive force, it is clear that the correlation is high. That is, a permeability, which is inversely proportional to the coercive force, has a high correlation with the generation amount of the ordered phase.

The generation amount of the ordered phase is likely to vary depending on heat treatment conditions. Therefore, in general, a variation in the permeability with respect to the heat treatment conditions tends to be large. Therefore, in order to reduce the variation in the permeability, it is effective to stabilize the generation amount of the ordered phase. As described above, at least one of C, P, and S, which are elements stabilizing the ordered phase, is included. On the other hand, the coercive force has a constant relationship with a magnetostriction constant, and the magnetostriction constant can also be stabilized by stable generation of the ordered phase. That is, it is possible to improve stability of a degree of order as an amount of the ordered phase against the heat treatment conditions and reduce a variation in the magnetostriction constant with respect to the heat treatment conditions. As a result, the variation in the permeability can also be reduced.

Using an alloy having the above-described composition, an amorphous single-phase alloy ribbon is obtained by rapidly cooling solidification using a single-roll method or the like, followed by a heat treatment to finely disperse and precipitate Fe—Si crystal grains, thereby obtaining a nanocrystalline soft magnetic material. At this time, the nanocrystalline soft magnetic material is produced to have a coercive force Hc of 1.0 A/m or less and a saturation magnetic flux density Bs of larger than 1.0 T.

As described above, by containing the element stabilizing the ordered phase, the generation amount of the ordered phase can be stabilized against the heat treatment conditions, and the variation in the magnetostriction constant due to the heat treatment can be reduced. Thus, it is possible to obtain a nanocrystalline soft magnetic material having a low coercive force and a high permeability with a smaller variation.

The coercive force Hc and a magnetostriction constant λₛ have a relationship as indicated by the following Expression (2), and the coercive force Hc can be minimized when the magnetostriction constant λₛ is zero. That is, it is effective to bring the magnetostriction constant as close to zero in order to stabilize the low coercive force. Here, a and b are constants, c is a constant of proportionality, and K is a magnetocrystalline anisotropy.

$${H}_{c} ∝ \frac{\vert aK \vert + \vert b {λ}_{s} \vert}{c} \qquad Expression ( 2 )$$

Here, the present inventors set the following expression as an order parameter S. A minus sign in the following expression (1) takes into consideration the fact that a magnetostriction constant of a B2 phase and a magnetostriction constant of a D0₃ phase have opposite signs.

S=v_{cry}·(χ_{D03}−χ_{B2}) Expression (1),

in Expression (1), v_{cry} represents a volume fraction (%) of a nanocrystalline phase, χ_{B2} represents an amount (%) of B2 phase, and χ_{D03} represents an amount (%) of D0₃ phase.

That is, in the case where the amount of B2 phase increases, the order parameter S decreases, and in the case where the amount of D0₃ phase increases, the order parameter S increases. In other words, the B2 phase is dominant in the case where the order parameter S is small, and the D0₃ phase is dominant in the case where the order parameter S is large. Signs of the magnetostriction constants satisfy λ_{s,B2}>0, λ_{s,D03}<0.

An amount of each phase is obtained based on an area ratio of peaks derived from each phase on an X-ray diffraction profile obtained by an X-ray diffraction method. Specifically, for the D0₃ phase and the B2 phase, a peak intensity ratio when each phase is 100% is obtained based on a peak intensity of an (hkl) plane in a powder X-ray diffraction database (PDF). Then, the following simultaneous equations are solved to obtain the amount of each phase. “Sₕₖₗ” is a measured peak intensity ratio of the (hkl) plane.

S₁₁₁=6.2×χ_{D03}

S₂₀₀=17.5×χ_{B2}+3.1χ_{D03}

A volume fraction of a nanocrystalline phase is calculated based on a ratio between an intensity Ic of a crystalline peak having a full width at half maximum of 5° or less at a peak in a 220 plane and an intensity Ia of an amorphous peak having a full width at half maximum of 5° or more at a peak in a 220 plane.

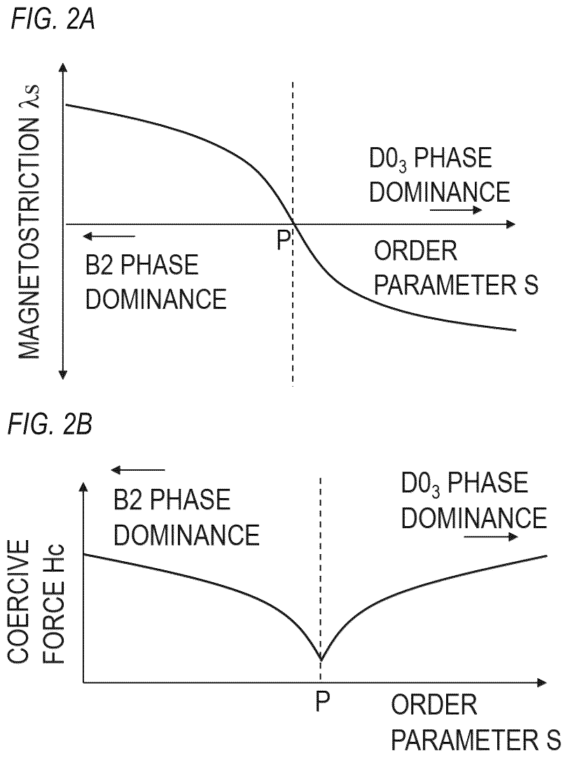

Here, as shown in FIG. 2A, in the case where the order parameter S is small, the B2 phase is dominant and the magnetostriction constant is positive, and, in the case where the order parameter S is large, the D0₃ phase is dominant and the magnetostriction constant is negative. On the other hand, according to the above-described Expression (2), the coercive force Hc decreases in the case where an absolute value of the magnetostriction constant λₛ decreases, and the coercive force Hc increases in the case where the absolute value of the magnetostriction constant as increases. That is, by controlling the order parameter S targeting a point P at which the magnetostriction constant λₛ is zero, the coercive force Hc can be brought close to a position where the coercive force Hc has a minimum value and stabilized at a low level (see FIG. 2B). It is found that the ordered phase can be controlled at a position close to such a point P by setting the order parameter S to be 20 to 30.

That is, it is preferable to set the order parameter S to be 20 to 30 to enable reduction in the variation in the magnetostriction constant with respect to the heat treatment.

### [Preliminary Test]

The present inventors studied a component composition of an alloy serving as a basis for obtaining the above-described nanocrystalline soft magnetic material. That is, by using an alloy to which C, P, and S, which are the elements stabilizing the degree of order, were not added, a range of a component composition of the alloy was determined to satisfy respective target values of the coercive force Hc of 1.0 A/m or less, the saturation magnetic flux density Bs of larger than 1.0 T, and an initial permeability of 100,000 or more.

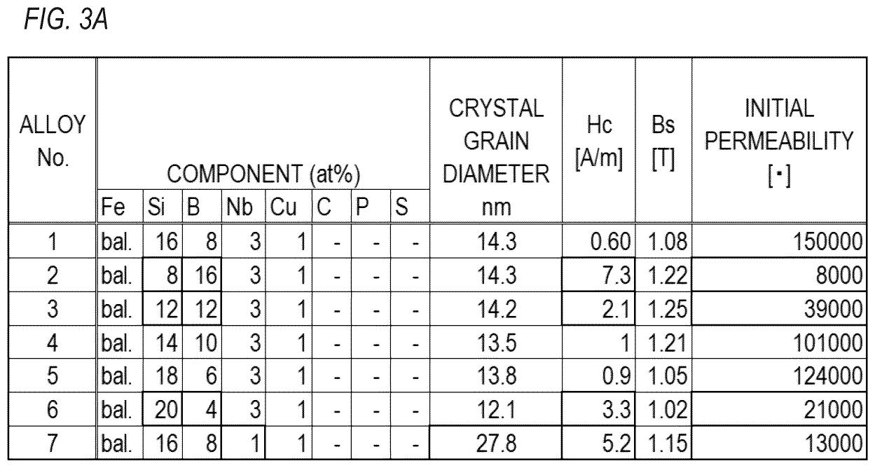

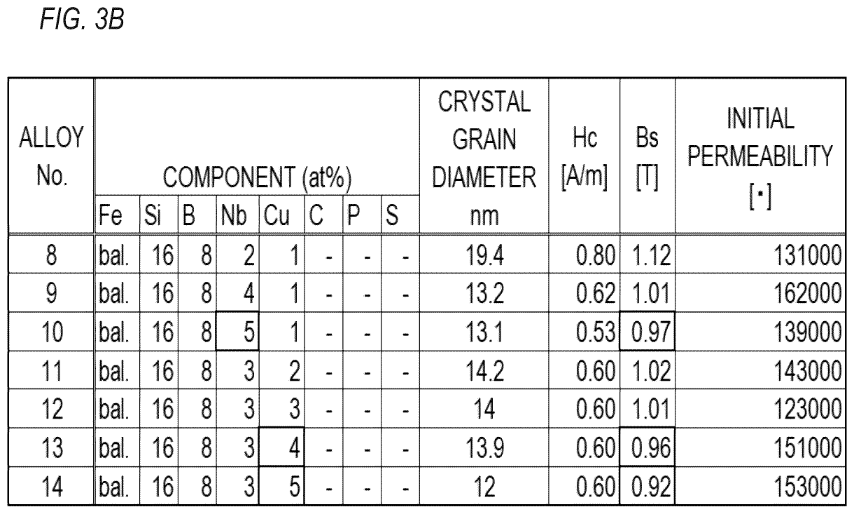

Specifically, an amorphous single-phase alloy ribbon was produced by a single roll method using alloys No. 1 to No. 14 having component compositions shown in FIG. 3A and FIG. 3B and subjected to a heat treatment at 580° C. for 30 minutes to measure a crystal grain diameter, the coercive force Hc, the saturation magnetic flux density Bs, and the initial permeability. The crystal grain diameter was obtained by a Rietveld analysis on an X-ray diffraction profile. In addition, with respect to the saturation magnetic flux density Bs, a toroidal core was prepared, an appropriate winding was provided, and the initial permeability was calculated by measuring an inductance at a frequency of 10 kHz under a condition that an applied magnetic field was 0.05 A/m. The inductance was measured using an impedance analyzer E4990A (manufactured by Keysight Technologies, Inc.). The coercive force Hc was measured using an Hc meter (coercive force meter).

Based on components of the alloys No. 1, No. 4, No. 5, No. 8, No. 9, No. 11, and No. 12 satisfying the above-described target values and the alloys No. 2, No. 3, No. 6, No. 7, No. 10, No. 13, and No. 14 not satisfying the above-described target values, regarding component compositions of alloys to be used in a production test to be described later, components excluding the elements stabilizing the ordered phase were studied. As the component composition, Si: 16%, B: 8%, Nb: 3%, and Cu: 1% were determined in terms of at %.

### [Production Test]

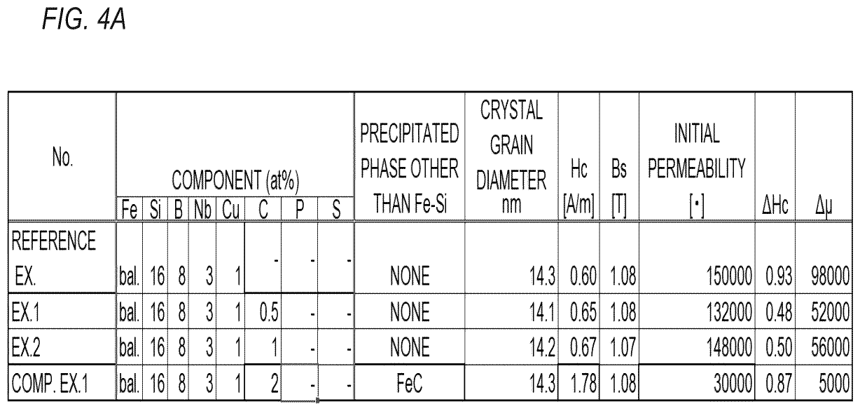

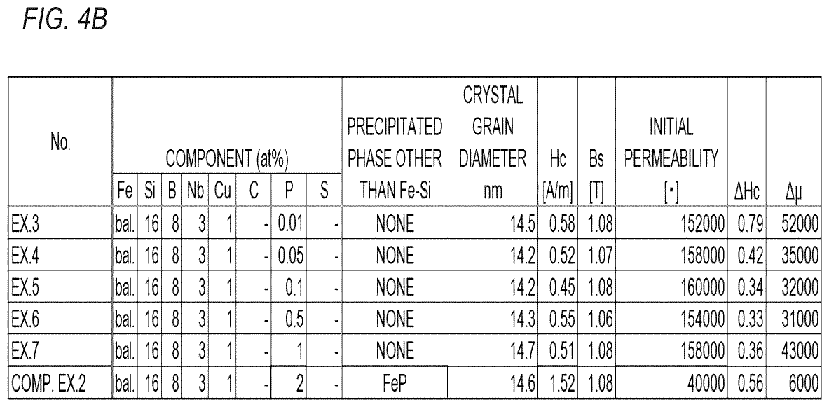

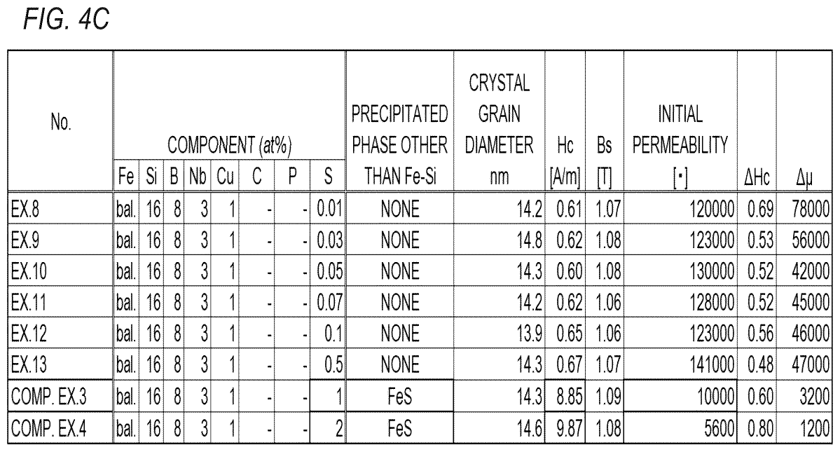

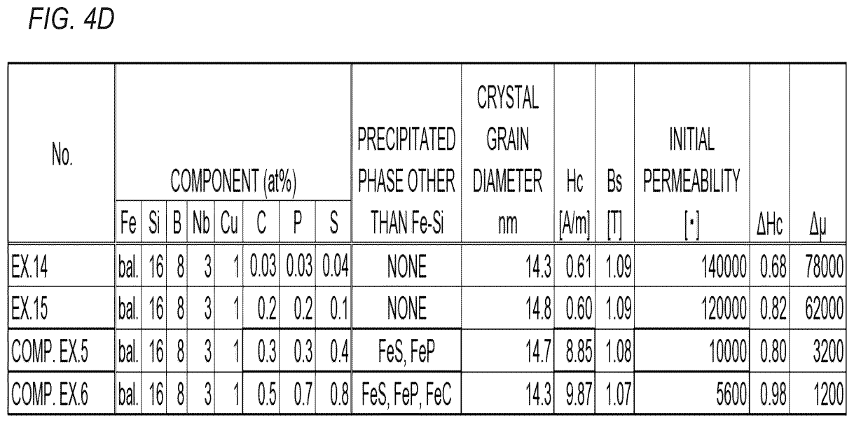

As shown in FIGS. 4A to 4D, an alloy ribbon was produced using an alloy obtained by adding C, P, and S, which are the elements stabilizing the ordered phase, to the component composition determined in the preliminary test, and the crystal grain diameter, the coercive force Hc, the saturation magnetic flux density Bs, and the initial permeability were measured in the same manner as in the preliminary test. Nine heat treatments obtained by combining three heat treatment temperatures, that is, 560° C., 580° C., and 600° C., with three holding times, that is, 10 minutes, 20 minutes, and 30 minutes, were performed, and the coercive force Hc and the initial permeability were measured for each case. Differences between maximum values and minimum values among the nine cases were recorded as a variation ΔHc in the coercive force Hc and a variation Δμ in the initial permeability, respectively. A target value of Δμ was set to be 80,000 or less.

First, as shown in Reference Example, in the case where none of C, P, and S, which are the elements stabilizing the ordered phase, was added, the variation Δμ in the initial permeability was large. That is, it is considered that the generation amount of the ordered phase is unstable due to the heat treatment conditions, the value of the order parameter S may be less than 20 or more than 30, and the variation in the initial permeability cannot be inhibited.

Referring to Examples 1 and 2, it was found that the variation Δμ in the initial permeability can be kept low by including C as the element stabilizing the ordered phase. However, it was found that, in the case where C was excessively included as in Comparative Example 1, FeC was generated as a precipitated phase other than Fe—Si, and as a result, the coercive force Hc was high and the initial permeability was low.

Referring to Examples 3 to 7, it was found that the variation Δμ in the initial permeability can be kept low by including P as the element stabilizing the ordered phase. However, it was found that, in the case where P was excessively included as in Comparative Example 2, FeP was generated as a precipitated phase other than Fe—Si, and as a result, the coercive force Hc was high and the initial permeability was low.

Referring to Examples 8 to 13, it was found that the variation Δμ in the initial permeability can be kept low by including S as the element stabilizing the ordered phase. However, it was found that, in the case where S was excessively included as in Comparative Examples 3 and 4, FeS was generated as a precipitated phase other than Fe—Si, and as a result, the coercive force Hc was high and the initial permeability was low.

Referring to Examples 14 and 15, it was found that in the case where C, P, and S, which are the element stabilizing the ordered phase, were included in combination, the variation Δμ in the initial permeability can still be kept low. However, it was found that, in the case where these elements were excessively included as in Comparative Examples 5 and 6, FeC, FeS, and FeP were generated as precipitated phases other than Fe—Si, and as a result, the coercive force Hc was high and the initial permeability was low. That is, it is preferable that the nanocrystalline soft magnetic material does not contain a compound formed between Fe, and C, P, or S.

Therefore, one or two or more of C, P, and S are included such that 0.01≤[C]+[P]+2[S]≤1.00 is satisfied, in which [M]% represents at % of an element M.

A composition range of a Fe-based alloy that can impart substantially the same soft magnetic property as that of the nanocrystalline soft magnetic material including the above example is determined as follows.

Si is used as an amorphous-forming element, and in particular, a content thereof was determined in order to bring the magnetostriction constant close to zero. Therefore, Si is within a range of 14.0% to 18.0%, preferably within a range of 15.0% to 17.0% in terms of at %.

B is used as an amorphous-forming element, but in the case where B is excessively included, a FeB compound is formed when nanocrystals are formed in the heat treatment, and magnetic properties decrease. In consideration of this, B is within a range of 6.0% to 10.0%, preferably within a range of 7.0% to 9.0% in terms of at %.

Nb is an element necessary for inhibiting coarsening of crystal grains precipitated during the heat treatment, but in the case where Nb is excessively included, the saturation magnetic flux density decreases. In consideration of this, Nb is in a range of 1.0% to 5.0%, preferably in a range of 2.5% to 3.5% in terms of at %.

Cu forms clusters and is finely dispersed in an amorphous matrix phase to inhibit coarsening of Fe—Si crystals. On the other hand, in the case where Cu is excessively included, the saturation magnetic flux density decreases. In consideration of this, Cu is within a range of 0.5% to 1.5%, preferably within a range of 0.7% to 1.0% in terms of at %.

As described above, C, P, and S are the elements stabilizing the ordered phase and reduce the variation in the magnetostriction constant with respect to the heat treatment. On the other hand, when excessively included, C, P, and S form compounds with Fe, and the magnetic properties decrease. In consideration of this, in the case where only C is included, C is in a range of more than 0.40% to 1.0% in terms of at %. In addition, in the case where at least P or S is contained, C, P, and S are within a range satisfying 0.01≤[C]+[P]+2[S]≤1.00, where [M]% is at % of an element M. Among these, in particular, in the case where S is in a range of 0.01 at % to 0.10 at %, a low coercive force can be maintained due to stabilization of an ordered phase amount and inhibition of precipitation of a compound phase, which is preferable. In the case where each of C, P, and S is contained, it is preferable that each of C, P, and S is contained in an amount of 0.01% or more in terms of at %. Each of C, P, and S is treated as an impurity when contained in an amount of less than 0.01%.

Although representative embodiments of the present invention have been described above, the present invention is not necessarily limited thereto, and various alternative embodiments and modifications may occur to those skilled in the art without departing from the spirit of the present invention or the scope of the appended claims. For example, the nanocrystalline soft magnetic material according to the present invention may be a pulverized powder material.

The present application is based on Japanese Patent Applications No. 2022-195522 filed on Dec. 7, 2022 and No. 2023-131660 filed on Aug. 10, 2023, and the contents thereof are incorporated herein by reference.

What is claimed is:

1. A nanocrystalline soft magnetic material in which Fe—Si crystal grains having an average grain diameter of 20 nm or less are dispersed in an amorphous matrix phase, the nanocrystalline soft magnetic material comprising:
an alloy composition comprising, in terms of at %,
Si: 14.0% to 18.0%,
B: 6.0% to 10.0%,
Nb: 1.0% to 5.0%,
Cu: 0.5% to 1.5%, and
C: more than 0.40% to 1.0%,
with the balance being Fe and unavoidable impurities, wherein
the nanocrystalline soft magnetic material has a coercive force Hc of 1.0 A/m or less and a saturation magnetic flux density Bs of larger than 1.0 T.

2. A nanocrystalline soft magnetic material in which Fe—Si crystal grains having an average grain diameter of 20 nm or less are dispersed in an amorphous matrix phase, the nanocrystalline soft magnetic material comprising:
an alloy composition comprising, in terms of at %,
Si: 14.0% to 18.0%,
B: 6.0% to 10.0%,
Nb: 1.0% to 5.0%,
Cu: 0.5% to 1.5%, and
at least one kind selected from the group consisting of C, P, and S provided that at least P or S is contained such that 0.01≤[C]+[P]+2[S]≤1.00 is satisfied, where [M]% is at % of an element M,
with the balance being Fe and unavoidable impurities, wherein
the nanocrystalline soft magnetic material has a coercive force Hc of 1.0 A/m or less and a saturation magnetic flux density Bs of larger than 1.0 T.

3. The nanocrystalline soft magnetic material according to claim 2, wherein
the alloy composition comprises, in terms of at %, S: 0.01% to 0.10%.

4. The nanocrystalline soft magnetic material according to claim 1, wherein
the Fe—Si crystal grains comprises a multiphase structure of a B2 phase and a D0₃ phase and have an order parameter S represented by the following expression (1) of 20 to 30,
S=v_{cry}·(χ_{D03}−χ_{B2}) Expression (1),
in Expression (1), v_{cry} represents a volume fraction (%) of a nanocrystalline phase, χ_{B2} represents an amount (%) of B2 phase, and χ_{D03} represents an amount (%) of D0₃ phase.

5. The nanocrystalline soft magnetic material according to claim 2, wherein
the Fe—Si crystal grains comprises a multiphase structure of a B2 phase and a D0₃ phase and have an order parameter S represented by the following expression (1) of 20 to 30,
S=v_{cry}·(χ_{D03}−χ_{B2}) Expression (1),
in Expression (1), v_{cry} represents a volume fraction (%) of a nanocrystalline phase, χ_{B2} represents an amount (%) of B2 phase, and χ_{D03} represents an amount (%) of D0₃ phase.

6. The nanocrystalline soft magnetic material according to claim 3, wherein
the Fe—Si crystal grains comprises a multiphase structure of a B2 phase and a D0₃ phase and have an order parameter S represented by the following expression (1) of 20 to 30,
S=v_{cry}·(χ_{D03}−χ_{B2}) Expression (1),
in Expression (1), v_{cry} represents a volume fraction (%) of a nanocrystalline phase, χ_{B2} represents an amount (%) of B2 phase, and χ_{D03} represents an amount (%) of D0₃ phase.

7. The nanocrystalline soft magnetic material according to claim 4, having an initial permeability of 100,000 or more.

8. The nanocrystalline soft magnetic material according to claim 5, having an initial permeability of 100,000 or more.

9. The nanocrystalline soft magnetic material according to claim 6, having an initial permeability of 100,000 or more.

10. The nanocrystalline soft magnetic material according to claim 1, comprising no compound formed between Fe, and C, P, or S.

11. The nanocrystalline soft magnetic material according to claim 2, comprising no compound formed between Fe, and C, P, or S.

12. The nanocrystalline soft magnetic material according to claim 3, comprising no compound formed between Fe, and C, P, or S.
